(19) United States
(12) Patent Application Publication
(10) Pub. No.: US 2012/0330712 A1
(43) Pub. Date: Dec. 27, 2012

(54) Graphical user interface for scheduling request

(76) Inventors: Yair Horovitz, Mazkeret Batya (IL); Dov Tendler, Jerusalem (IL); Yuval Koren, Rishon LeTzion (IL); Tom Rosenberg, Tel Aviv-Jaffo (IL)

(21) Appl. No.: 13/169,001

(22) Filed: Jun. 26, 2011

(51) Int. Cl. G06Q 10/00

(52) U.S. Cl. 705/7.25

(57) ABSTRACT

A graphical user interface (GUI) is displayed. The GUI indicates a start time when any of a number of particular resources is available for an entirety of a contiguous block of time. The contiguous block of time is specified by a scheduling request including a non-specific resource. Each particular resource individually satisfies the scheduling request.

### BACKGROUND

Resources can include computing resources, such as computing devices like servers, as well as other types of computing resources. Resources can also include human resources, such as members of a project team, as well as other types of human resources. Resources are commonly scheduled. For instance, a developer may want to schedule a computing device to run a test on for a period of time. As another example, a manager may want to schedule a meeting with one or more members of a project team to discuss the project.

### BRIEF DESCRIPTION OF THE DRAWINGS

FIG. 1 is a diagram depicting example hour-by-hour availability of two example resources.

FIG. 2 is a diagram of an example graphical user interface (GUI) by which a non-specific resource pertaining to the two example resources of FIG. 1 can be scheduled for an example two-hour contiguous block of time.

FIGS. 3A and 3B are diagrams of another example GUI by which a non-specific resource pertaining to the two example resources of FIG. 1 can be scheduled for an example two-hour contiguous block of time.

FIG. 4 is a flowchart of an example method for fulfilling a scheduling request including a non-specific resource.

FIG. 5 is a diagram of an example system for fulfilling a scheduling request including a non-specific resource.

### DETAILED DESCRIPTION

As noted in the background section, resources such as computing resources, human resources, and other types of resources, are commonly scheduled. One type of resource that may be scheduled is referred to herein as a non-specific resource. A non-specific resource specifies a type of resource without necessarily specifying any individual resource in particular.

For instance, a non-specific resource may be any computing device within a set of computing devices that have been reserved for running development tests. The resource is non-specific in that it does not specify any particular computing device with this set. For example, if there are four computing devices A, B, C, and D that have been reserved for running development tests, the non-specific resource specifies any of these four computing devices, without particularly specifying computing device, A, B, C, or D. A developer may want to schedule, for a contiguous block of time, any of these computing devices. The developer does not care which of these computing devices is scheduled to run his or her test, but the same computing device has to be available for the entirety of the contiguous block of time.

A non-specific resource may further be any member of a given project team. The resource is non-specific in that it does not specify any particular member of the team. For example, if there are two team members Alice and Bob, the non-specific resource specifies any of these team members, without particularly specifying either Alice or Bob. A manager may want to schedule a meeting, for a contiguous block of time, with either of these team members. The manager does not care which team member—Alice or Bob—attends the meeting, but the team member that does attend has to be available for the entirety of the meeting.

In both these cases, then, it is said that a non-specific resource pertains to a number of particular resources, be they the actual computing devices of the set of computing devices in the former example, or the actual team members of the project team in the latter example. A scheduling system may thus identify a subset of the particular resources that each individually satisfy the scheduling request. For instance, where the scheduling request specifies a contiguous block of time that the non-specific resource is desired, the subset of the particular resources that are each available for the entirety of this contiguous block of time is determined. However, existing scheduling systems do not convey this information in a clear manner to a user, making this functionality difficult to employ by users.

Disclosed herein are techniques to provide this information to a user by displaying a suitable graphical user interface (GUI). Identification of each of a subset of resources is received. The subset of resources is a subset of a set of resources. The set of resources are the resources to which a non-specific resource of a scheduling request pertains. The scheduling request specifies a contiguous block of time in which the non-specific resource is to be scheduled. Each particular resource of the subset individually satisfies the scheduling request.

A GUI is displayed that indicates the start times when any of the particular resources of the subset is available for an entirety of the contiguous block of time. In this way, a user can easily discern when a particular resource is available that satisfies the scheduling request. The user may not care which particular resource satisfies the scheduling request, but rather just that the same particular resource is available for the entirety of the contiguous block of time specified by the scheduling request. The user may then be able to select a start time at which he or she wishes to schedule one of the particular resources to which the scheduling request pertains, and that satisfy the scheduling request.

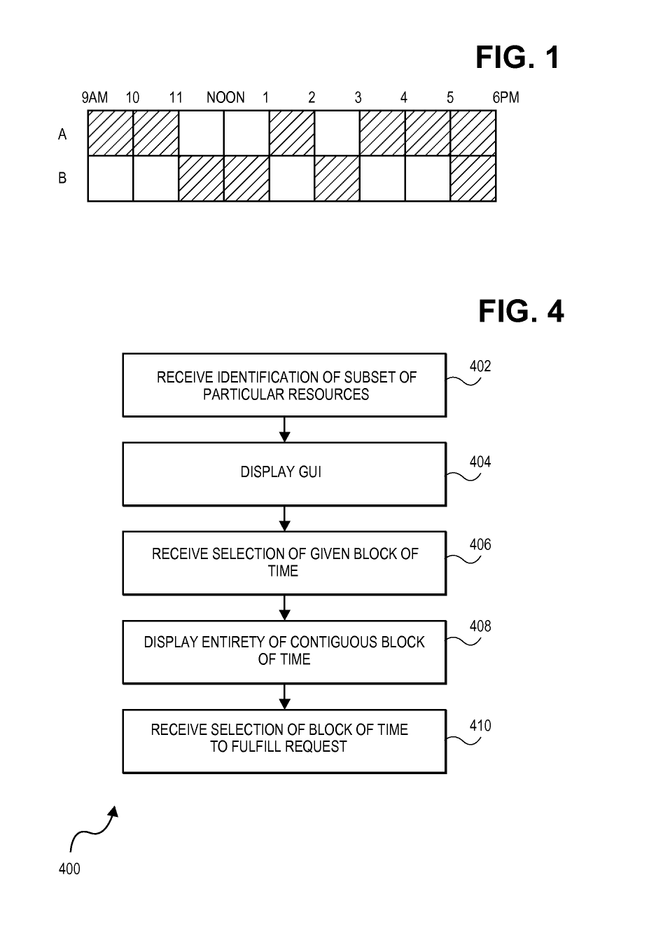

Example illustrative depiction of the above is now presented. Consider the example scenario of FIG. 1, in which there are two particular resources A and B of the same type and to which a non-specific resource of a scheduling request pertains. For instance, the resources A and B may be two computing devices on which development tests can be run, two team members of the same project team, and so on.

Availability of each resource A and B is depicted in FIG. 1 on an hourly basis from 9 AM to 6 PM. A block of time is shaded where a resource is not available for a block of time, and is not shaded where a resource is available for a block of time. In the example of FIG. 1, the resource A is available between 11 AM and 1 PM and between 2 PM and 3 PM, and is otherwise unavailable between 9 AM and 6 PM. The resource B is available between 9 AM and 11 AM, between 1 PM and 2 PM, and between 3 PM and 5 PM, and is otherwise unavailable.

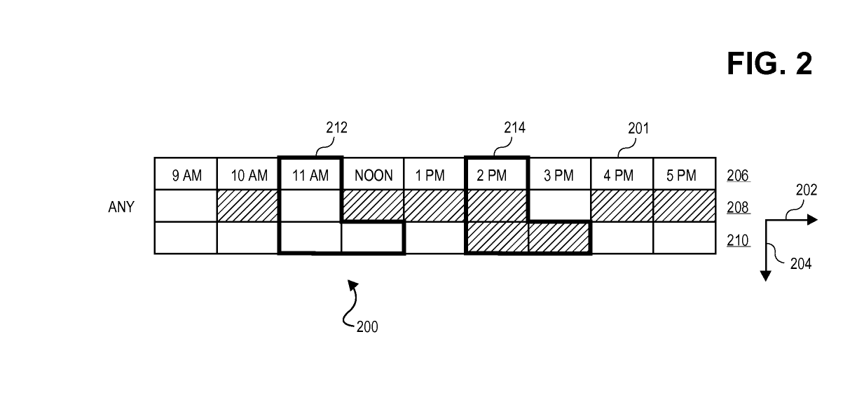

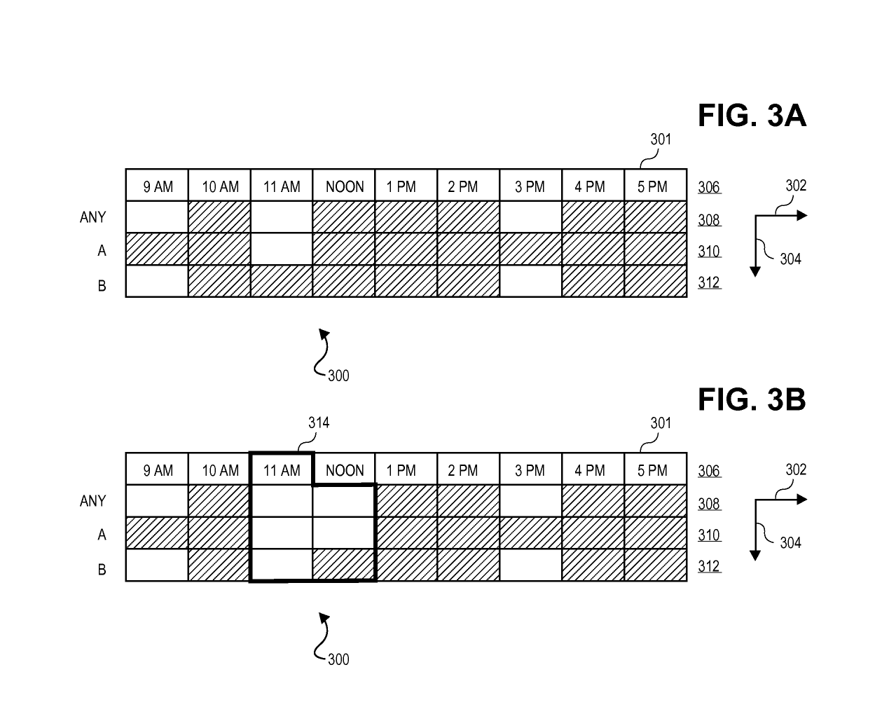

For example purposes, it is assumed that the scheduling request for a non-specific resource that pertains to the particular resources A and B, for a two-hour contiguous block of time between 9 AM and 6 PM. FIG. 2 shows a first example GUI 200, and FIGS. 3A and 3B show a second example GUI 300, each of which can be employed to assist a user in discerning which two-hour contiguous blocks of time are available to schedule the particular resource A or the particular resource B to which the non-specific resource of the scheduling request pertains. The difference between the example GUIs 200 and 300 is that the former does not identify the particular resources A and B, whereas the latter does.

Referring first specifically to FIG. 2, the GUI 200 includes a grid 201 organized over a horizontal axis 202 and a vertical axis 204 that are perpendicular to one another. The horizontal axis 202 denotes one-hour blocks of time between 9 AM and 6 PM. Along the vertical axis 204, the grid 201 includes three rows 206, 208, and 210. The rows 206, 208, and 210 can more generally be referred to as GUI elements.

The row 206 identifies the starting time for each one-hour block of time. The row 208 indicates the availability of the non-specific resource (i.e., either resource A or B) for the entirety of the two-hour contiguous block of time starting at each block of time. That is, neither particular resource A or B is indicated in the grid 201, but rather the non-specific resource that pertains to both resources A and B is indicated by the label “ANY.” The row 208 is shaded where neither resource A or B is unavailable to start at a block of time for the full two-hour contiguous block of time of the scheduling request, and is not shaded where either resource A or B is available to start at a block of time for these full two hours.

As such, the block of time between 9 AM and 10 AM is not shaded in the row 208. This is because the resource B is available for two hours between 9 AM and 11 AM (i.e., beginning at 9 AM), as depicted in FIG. 1, in correspondence with the scheduling request. The block of time between 10 AM and 11 AM is shaded in the row 208 even though the resource B is available during this time, as depicted in FIG. 1, because the scheduling request is for two contiguous hours of the non-specific resource, and the resource B (or the resource A) is not available for two contiguous hours starting at 10 AM, but rather just for one hour.

The block of time between 11 AM and noon is not shaded in the row 208. This is because the resource A is available for two hours between 11 AM and 1 PM beginning at 11 AM, as depicted in FIG. 1, in correspondence with the scheduling request. The block of time between noon and 1 PM is shaded in the row 208 even though the resource A is available during this time, as depicted in FIG. 1, because the scheduling request is for two contiguous hours of the non-specific resource, and the resource A (or the resource B) is not available for two contiguous hours starting at noon, but rather just for one hour.

The block of time between 3 PM and 4 PM is not shaded in the row 208. This is because the resource B is also available for two hours beginning at 3 PM, as depicted in FIG. 1, in correspondence with the scheduling request. The block of time between 4 PM and 5 PM is shaded in the row 208 even though the resource B is available during this time, as depicted in FIG. 1, because the scheduling request is for two contiguous hours of the non-specific resource, and the resource B (or the resource A) is not available for two contiguous hours starting at 4 PM, but rather just for one hour.

Therefore, the row 208 indicates whether either resource A or B to which the non-specific resource pertains is available for the two contiguous hours specified in the scheduling request starting at each block of time. The GUI 200 also permits a user to select a block of time, and responsively highlights the two contiguous hours of the scheduling request in row 210 in one of two different manners. The manner in which each block of time of the contiguous block of time of the scheduling request is highlighted in row 210 depends whether either resource A or B is available or whether either resource A or B is unavailable for scheduling during these blocks of time.

For example, assume that the user selects the block of time corresponding to a start time of 11 AM, as indicated by reference number 212 in FIG. 2. The non-specific resource (i.e., either resource A or B) is available for the entirety of the two-hour contiguous block of time starting at 11 AM. Therefore, each block of time of the two-hour contiguous block of time is highlighted in the row 210 by being at least partially surrounded by a box, which may be in a first color like green, and is not shaded. In this way, the user can easily discern that the non-specific resource can be scheduled beginning at 11 AM, per the row 208, and that the non-specific resource can specifically be scheduled for two hours beginning at this time, per the row 210.

As another example, assume that the user instead selects the block of time corresponding to a start time of 2 PM, as indicated by reference number 214 in FIG. 2. The non-specific resource (i.e., either resource A or B) is unavailable for the entirety of the two-hour contiguous block of time starting at 11 AM. Therefore, each block of time of the two-hour contiguous block of time is highlighted in the row 210 by being at least partially surrounded by a box, which may be in a second color like red, and is shaded. In this way as well, the user can easily discern that the non-specific resource cannot be scheduled at 2 PM, per the row 208, and that the non-specific resource cannot specifically be scheduled for two hours beginning at this time, per the row 210.

The following deserves emphasis. As depicted in FIG. 1, the resource B is available between 10 AM and 11 AM, and the resource A is available between 11 AM and noon. However, in FIG. 2, the block of time between 10 AM and 11 AM is shaded in the row 208 to indicate that the non-specific resource is unavailable for two contiguous hours starting at 10 AM. This is because even though the resource B is available between 10 AM and 11 AM, and the resource A is available between 11 AM and noon, neither resource A nor B is available for the entirety of the two hours, as specified in the scheduling request, between 10 AM and noon.

That is, a scheduling request for a non-specific resource does not mean that any particular resource to which the non-specific resource pertains can fill any block of time to fulfill the request. Rather, the scheduling request means that the same particular resource (regardless of which particular resource)—i.e., just one particular resource—to which the non-specific request pertains has to fill each block of time to fulfill the request. This is also the reason why the blocks of time between noon and 1 PM, between 1 PM and 2 PM, and between 2 PM and 3 PM are shaded in FIG. 2.

Referring next specifically to FIG. 3A, the GUI 300 includes a grid 301 organized over a horizontal axis 302 and a vertical axis 304 that are perpendicular to one another. The horizontal axis 302 denotes one-hour blocks of time between 9 AM and 6 PM. Along the vertical axis 304, the grid 301 includes four rows 306, 308, 310, and 312. The rows 306, 308, 310, and 312 can more generally be referred to as GUI elements.

The row 306 identifies the starting time for each one-hour block of time, and thus is identical to the row 206 of FIG. 2 that has been described. The row 308 indicates the availability of the non-specific resource (i.e., either resource A or B) for the entirety of the two-hour contiguous block of time starting at each block of time. In this respect, the row 308 is identical to the row 208 of FIG. 2 that has been described.

The row 310 indicates the availability of the particular resource A for the entirety of the two-hour contiguous block of time starting at each block of time. Similarly, the row 312 indicates the availability of the particular resource B for the entirety of the two-hour contiguous block of time starting at each block of time. Each of the rows 310 and 312 is shaded for its particular resource where the particular resource is unavailable to start at a block of time for the full two-hour contiguous block of time of the scheduling request. Each of the rows 310 and 312 is not shaded for its particular resource where the particular resource is available to start at a block of time for these full two hours.

As such, for the particular resource A, just the block of time between 11 AM and noon is not shaded in the row 310. This is because the resource A is available for two hours between 11 AM and 1 PM (i.e., beginning at 11 AM), as depicted in FIG. 1, in correspondence with the scheduling request. The block of time between noon and 1 PM, and the block of time between 2 PM and 3 PM, are shaded in the row 310, however, even though the resource A is available during these times, as depicted in FIG. 1. This is because the scheduling request is for two contiguous hours of the non-specific resource, and the resource A is unavailable for two contiguous hours starting at noon or at 2 PM, but rather just for one hour.

For the particular resource B, just the blocks of time between 9 AM and 10 AM and between 3 PM and 4 PM are not shaded in the row 312. This is because the resource B is available for two hours between 9 AM and 11 AM (i.e., beginning at 9 AM) and between 3 PM and 5 PM (i.e., beginning at 3 PM), as depicted in FIG. 1, in correspondence with the scheduling request. The blocks of time between 10 AM and 11 AM, between 1 PM and 2 PM, and between 4 PM and 5 PM, are shaded in the row 312, however, even though the resource B is available during these times, as depicted in FIG. 1. This is because the scheduling request is for two contiguous hours of the non-specific resource, and the resource B is unavailable for two contiguous hours starting at 10 AM, at 1 PM, or at 4 PM, but rather just for one hour.

Therefore each of the rows 310 and 312 indicates whether its particular resource to which the non-specific resource pertains is available for the two contiguous hours specified in the scheduling request starting at each block of time. The following deserves emphasis. As depicted in FIG. 1, the resource B is available between 10 AM and 11 AM, and the resource A is available between 11 AM and noon. However, in FIG. 3, the rows 308, 310, and 312 are each shaded between 10 AM and 11 AM, indicating that neither the resource A nor the resource B—and thus not the non-specific resource either—is available. This is because the scheduling request in question for the non-specific resource specifies two contiguous hours. While either the resource A or the resource B is available between 10 AM and noon (i.e., the resource B between 10 AM and 11 AM, and the resource A between 11 AM and noon), neither the resource A nor the resource B is itself individually available for both hours.

It is noted that a scheduling request for a non-specific resource does not mean that any particular resource to which the non-specific resource pertains can fill any block of time to fulfill the request. Rather, such a scheduling request means that the same particular resource (regardless of which particular resource)—i.e., just one particular resource—to which the non-specific request pertains has to fill each block of time to fulfill the request. This is also why the blocks of time between noon and 1 PM, between 1 PM and 2 PM, and between 2 PM and 3 PM are shaded in the rows 308, 310, and 312 in FIG. 3A.

It is further noted that the scheduling request may be for multiple non-specific resources, such as any two, three, and so on, particular resources to which the non-specific resource pertains. A non-specific resource specifies one or more particular resources insofar as the non-specific resource may specify a type of resource of which the particular resources are particular instances. As one example, a non-specific computing resource may specify particular resources that have a certain speed, location, memory, and so on.

The GUI 300 of FIG. 3A permits a user to select any particular block of time, and responsively highlights each block of time of the contiguous block of time of the scheduling request starting at the particular block of time selected, in one of two different manners. Each such block of time is highlighted in one of these two different manners in rows 308, 310, and 312 for the non-specific resource, the particular resource A, and the particular resource B, respectively. The manner in which each such block of time of the scheduling request is highlighted in each of the rows 308, 310, and 312 depends on whether the corresponding resource is actually unavailable or available during this block of time. An example of such selection and resulting highlighting is now described in detail in relation to FIG. 3B.

FIG. 3B shows an example of the GUI 300 of FIG. 3A after the user has selected the block of time corresponding to a start time of 11 AM, as indicated by a border 314 in FIG. 3B. The border 314 encompasses just the block of time corresponding to the start time of 11 AM within the row 306. However, the border 314 encompasses both contiguous blocks of time of the scheduling request starting at 11 AM—i.e., both the block of time starting at 11 AM and the block of time starting at noon—within the rows 308, 310, and 312.

Within the blocks of time within the rows 308, 310, and 312 encompassed by the border 314, the grid 300 shows whether the corresponding resources are available or unavailable during each block of time. For the non-specific resource to which the row 308 corresponds, the particular resource A is available for the entirety of the two-hour contiguous block of time starting at 11 AM, but the particular resource B is not. As such, both the block of time starting at 11 AM and the block of time starting at noon are highlighted in the row 308 for the non-specific resource by not being shaded, since one of the particular resources A and B (specifically, the resource A) is available for the contiguous two-hour block of time of the scheduling request starting at 11 AM.

Note, therefore, that once the user selects the block of time corresponding to a start time of 11 AM, the block of time starting at noon is no longer shaded in FIG. 3B within the row 308, although this block of time was shaded in FIG. 3A within the row 308. This is because prior to the selection of the block of time corresponding to a start time of 11 AM, the block of time starting at noon indicated in FIG. 3A whether the non-specific resource is available for two contiguous hours starting at noon. By comparison, once the block of time corresponding to a start time of 11 AM has been selected, as in FIG. 3B, the block of time starting at noon within the row 308 shows that the non-specific resource is available at this time, as part of the contiguous two-hour block of time of the scheduling request starting at the selected time of 11 AM.

Similarly, both the block of time starting at 11 AM and the block of time starting at noon are highlighted in the same manner (i.e., by not being shaded) in the row 310 for the particular resource A, since the resource A is available for the contiguous two-hour block of time of the scheduling request starting at 11 AM. Here, too, once the user selects the block of time corresponding to a start time of 11 AM, the block of time starting at noon is no longer shaded in FIG. 3B within the row 310, although this block of time was shaded in FIG. 3A within the row 310. This is because prior to the selection of the block of time corresponding to a start time of 11 AM, the block of time starting at noon indicated in FIG. 3A whether the particular resource A is available for two contiguous hours starting at noon. By comparison, once the block of time corresponding to a start time of 11 AM has been selected, as in FIG. 3B, the block of time starting at noon within the row 310 shows that the particular resource A is available at this time, as part of the contiguous two-hour block of time of the scheduling request starting at the selected time of 11 AM.

For the particular resource B, the block of time starting at 11 AM is highlighted in the same manner (i.e., by not being shaded) in the row 312, since the resource B is available within the block of time starting at 11 AM. However, the block of time starting at noon is highlighted in a different manner (i.e., by being shaded) in the row 312, since the resource B is unavailable within the block of time starting at noon. Note in this respect how the row 312 in FIG. 3B differs from the row 312 in FIG. 3A. Prior to the selection of the block of time corresponding to a start time of 11 AM, the blocks of time starting at 11 AM and at noon are shaded in FIG. 3A, because the resource B is unavailable for two contiguous hours starting at either 11 AM or at noon. By comparison, once the block of time corresponding to a start time of 11 AM has been selected, as in FIG. 3B, the block of time starting at 11 AM is not shaded within the row 312 for the particular resource B, because the resource B is available during the block of time starting at 11 AM. The block of time corresponding to a start time of noon remains shaded in FIG. 3B within the row 312, because the resource B is not available during the block of time starting at noon.

The example highlighting described in relation to FIG. 3B thus permits a user to view the actual availability of each resource, including the non-specific resource, for each block of time of the contiguous block of time of the scheduling request, starting at the block of time that has been selected. In FIG. 3A, the user can discern that the non-specific resource and the particular resource A are available for the two contiguous hours of the example scheduling request, because the rows 308 and 310 are not shaded at the block of time starting at 11 AM. Similarly, the user can discern that the particular resource B is unavailable for these two contiguous hours in FIG. 3A, because the row 312 is shaded at the block of time starting at 11 AM. However, in FIG. 3B, the user can discern that the reason why the particular resource B is unavailable for the two contiguous hours starting at 11 AM is because the resource B is unavailable for the block of time starting at noon, even though the resource B is available for the block of time starting at 11 AM.

FIG. 4 shows an example method 400 for fulfilling a scheduling request. The scheduling request includes (i.e., specifies) a non-specific resource. The method 400 may be implemented as a computer program executable by a processor of a computing device, such as a computing device that is or is part of a resource scheduling system. Execution of the computer program by the processor thus results in performance of the method 400.

The method 400 receives identification of each particular resource of a subset of particular resources that satisfy a scheduling request (402). For example, this information may be received from a part of a scheduling computer program, where the method 400 is implemented as another part of the scheduling computer program, such as a plug-in thereof. As another example, this information may be received from a scheduling computer program, where the method 400 is implemented as another computer program.

The scheduling request specifies a contiguous block of time in which a non-specific resource is to be scheduled, as described above. For instance, the non-specific resource may specify resources of a particular type. There may be particular resources of this type, as well as particular resources of other types. The former resources are thus identified as the subset of the resources that satisfy the scheduling request. Each particular resource of the subset thus individually satisfies the scheduling request.

The method 400 displays a GUI indicating a start time when any of the particular resources of the subset is available for an entirety of the contiguous block of time specified within the scheduling request (404). The GUI that is displayed may be the GUI 200 of FIG. 2 or the GUI 300 of FIG. 3, for instance. The GUI may be another type of GUI as well.

The method 400 can receive selection of a given block of time (406). For instance, a user may use a pointing device communicatively connected to a computing device that is executing the method 400 to select the given block of time. In response, the method 400 displays each block of time of the contiguous block of time in a first manner or a second manner, starting at the given block of time selected, as has been described above in relation to 212 and 214 of FIG. 2 and in relation to 314 of FIG. 3B.

Ultimately, the method 400 can receive selection of a block of time, such as by a user as noted above, to fulfill the scheduling request (410). For instance, upon viewing the GUI 200 or 300, the user may select a block of time to fulfill the scheduling request. The method 400 can then transmit this information to a different part of a scheduling computer program, or to the scheduling computer program, so that one of the particular resources of the subset can be appropriately scheduled to fulfill the scheduling request.

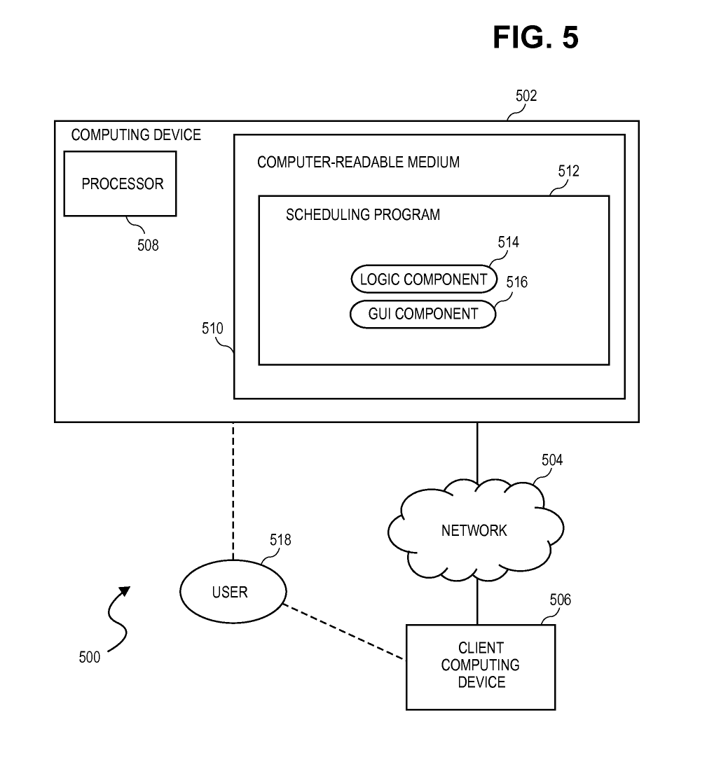

FIG. 5 shows an example scheduling system 500. The system 500 includes at least a processor 508 and a computer-readable data storage medium 510 that may be part of a computing device 502. The system 500 may also include a network 504 and a client computing device 506. The network 504 may be or include the Internet, an intranet, an extranet, a wireless network, a wired network, a telephony network, and so on. The network 504 permits the computing devices 502 and 506 to communicatively connect to one another.

The computer-readable data storage medium 510 stores a scheduling computer program 512 that is executable by the processor 508 to perform the method 400 of FIG. 4. As such, the scheduling computer program 512 can include a logic component 514 and a GUI component 516. The logic component 514 may determine the particular resources to which a non-specific resource of a scheduling request pertains, and may determine the subset of these particular resources that can satisfy the scheduling request. As such, the logic component 514 provides the identification of each particular resource of the subset to the GUI component 516.

The GUI component 516 in turn can display a GUI as has been described in relation to FIGS. 2 and 3. The GUI component 516 can further permit the user 518 to select within this grid a block of time at which a particular resource of the subset is available to satisfy the scheduling request. As such, the GUI component 516 can perform the method 400 of FIG. 4. The user 518 can in some implementations interact directly with the computing device 502, via suitable input devices like keyboards, mice, track pads, and so on, to issue or provide the scheduling request, and to select an available block of time within the grid displayed by the computing device 502 on a display device.

The user 518 can in the same or other implementations interact indirectly with the computing device 502, via the client computing device 506 communicating with the computing device 502 over the network 506, to perform this same functionality. For instance, the user 518 may enter his or her scheduling request at the client computing device 506, which then conveys this scheduling request to the computing device 502. The computing device 502 may then convey back information corresponding to the GUI for display by the client computing device 506 to the user 518.

The computer-readable data storage medium 510 that stores the scheduling computer program 512 can be a non-transitory computer-readable medium, such as a magnetic medium, an optical medium, a volatile medium, and/or a non-volatile medium, among other types of computer-readable media. The scheduling computer program 512 may itself be part of another computer program, like a personal-information management computer program as just one example. The scheduling computer program 512 may be implemented as a standalone computer program, as a web service that may be available at a web site on the Internet, and so on.

It is noted that the techniques disclosed herein encompass a multitude of different scenarios involving non-specific resource. For instance, a scheduling request may pertain to scheduling one or more non-specific resources in combination with one or more specific resources. As an example, a scheduling request may specify a specific, or particular, resource, as well as a non-specific resource.

A scheduling request may further pertain to scheduling multiple non-specific resources. As an example, a scheduling request may specify two first non-specific resources and one second non-specific resource. The first non-specific resources may be location based (i.e., non-specific resources at a particular location). The second non-specific resource may be characteristic based (i.e., a non-specific resource having a particular operating system, or at least a particular amount of memory installed therein).

1. A method comprising:
receiving, by a processor, identification of each of a subset of a plurality of particular resources, the plurality of particular resources to which a non-specific resource of a scheduling request pertains, the scheduling request specifying a contiguous block of time in which the non-specific resource to be scheduled, each particular resource of the subset individually satisfying the scheduling request; and,
displaying a graphical user interface (GUI), by the processor, indicating a start time when any of the particular resources of the subset is available for an entirety of the contiguous block of time.

2. The method of claim 1, wherein displaying the GUI comprises displaying a grid having a first axis and a second axis,
wherein the first axis specifies blocks of time, and the second axis specifies the non-specific resource without identifying any of the subset of the particular resources that each individually satisfy the scheduling request,
and wherein for each block of time,
the grid shows that the non-specific resource is available if any of the subset of the particular resources is available for the entirety of the contiguous block of time starting at the block of time, and
the grid shows that the non-specific resource is unavailable if none of the subset of the particular resources are available for the entirety of the contiguous block of time starting at the block of time.

3. The method of claim 2, further comprising, in response to receiving selection of a given block of time:
where if any of the subset of the particular resources is available for the entirety of the contiguous block of time starting at the given block of time, highlighting in a first manner the entirety of the contiguous block of time starting at the given block of time; and,
where if none of the subset of the particular resources are available for the entirety of the contiguous block of time starting at the given block of time, highlighting in a second manner the entirety of the contiguous block of time starting at the given block of time.

4. The method of claim 1, wherein displaying the GUI comprises displaying a grid having a first axis and a second axis,
wherein the first axis specifies blocks of time, and the second axis specifies at least each particular resource of the subset of the particular resources that each individually satisfy the scheduling request,
and wherein for each block of time and for each particular resource of the subset of the particular resources that each individually satisfy the scheduling request,
the grid shows that the particular resource of the subset is available if the particular resource is available for the entirety of the contiguous block of time starting at the block of time, and
the grid shows that the particular resource of the subset is unavailable if the particular resource is unavailable for the entirety of the contiguous block of time starting at the block of time.

5. The method of claim 4, wherein the second axis further specifies the non-specific resource,
and wherein for each block of time,
the grid shows that the non-specific resource is available if any of the subset of the particular resources is available for the entirety of the contiguous block of time starting at the block of time, and
the grid shows that the non-specific resource is unavailable if none of the subset of the particular resources are available for the entirety of the contiguous block of time starting at the block of time.

6. The method of claim 4, further comprising, in response to receiving selection of a given block of time, for each resource of the non-specific resource and the particular resources:
for each block of time of the contiguous block of time starting at the given block of time, highlighting the block of time in a first manner where the resource is actually available; and,
for each block of time of the contiguous block of time starting at the given block of time, highlighting the block of time in a second manner where the resource is actually unavailable.

7. The method of claim 1, wherein the non-specific resource specifies a type of resource without necessarily specifying any individual resource,
and wherein the particular resources are each an actual individual resource.

8. The method of claim 1, further comprising receiving selection of a block of time for which one of the particular resources of the subset satisfies the scheduling request, to schedule the one of the particular resources to fulfill the scheduling request.

9. A system comprising:
a processor; and,
a computer-readable data storage medium storing a computer program executable by the processor to display a graphical user interface (GUI) indicating each of a plurality of start times in a first manner or a second manner,
wherein the GUI indicates each start time in the first manner when any of a plurality of particular resources is available for an entirety of a contiguous block of time specified by a scheduling request pertaining to a type of the particular resources,
wherein the GUI indicates each start time in the second manner when none of the plurality of particular resources is available for the entirety of the contiguous block of time specified by the scheduling request pertaining to the type of the particular resources,
wherein the GUI comprises a first element, and for each of a plurality of blocks of time corresponding to the plurality of start times and for each particular resource that is available for the entirety of the contiguous block of time starting at the block of time,
the first element shows that the particular resource is unavailable if the particular resource is unavailable for the entirety of the contiguous block of time starting at the block of time,
the first element shows that the particular resource is available if the particular resource is available for the entirety of the contiguous block of time starting at the block of time
wherein the GUI further comprises a second element corresponding to the first element and corresponding to a non-specific resource pertaining to the plurality of particular resources,
and wherein for each block of time,
the second element shows that the non-specific resource is available if any of the subset of the particular resources is available for the entirety of the contiguous block of time starting at the block of time, and
the second element shows that the non-specific resource is unavailable if none of the subset of the particular resources are available for the entirety of the contiguous block of time starting at the block of time.

10. The system of claim 9, wherein the GUI further comprises a third element indicating, for each of a plurality of blocks of time corresponding to the plurality of start times, availability if any of the particular resources is available for the entirety of the contiguous block of time starting at the block of time.

11. The system of claim 10, wherein the GUI further comprises a fourth element corresponding to the third element and indicating the blocks of time.

12. The system of claim 10, wherein the GUI further comprises a fourth element corresponding to the third element,
and wherein the component, responsive to receiving selection of a given block of time, is to:
where if any of the particular resources is available for the entirety of the contiguous block of time starting at the given block of time, highlight in the first manner the entirety of the contiguous block of time starting at the given block of time, within the fourth element; and,
where if none of the particular resources is available for the entirety of the contiguous block of time starting at the given block of time, highlight in the second manner the entirety of the contiguous block of time starting at the given block of time, within the fourth element.

13. (canceled)

14. (canceled)

15. A non-transitory computer-readable data storage medium storing a computer program executable by a processor to perform a method comprising:
receiving identification of each of a subset of a plurality of particular resources, the plurality of particular resources to which a non-specific resource of a scheduling request pertains, the scheduling request specifying a contiguous block of time in which the non-specific resource to be scheduled, each particular resource of the subset individually satisfying the scheduling request; and,
displaying a graphical user interface (GUI) indicating a start time when any of the particular resources of the subset is available for an entirety of the contiguous block of time, by one or more of:
for each of a plurality of blocks of time, indicating availability if any of the particular resources of the subset is available for the entirety of the contiguous block of time starting at the block of time;
for each block of time and for each particular resource of the subset, indicating availability if the particular resource is available for the entirety of the contiguous block of time starting at the block of time.
